(19) United States
(12) Patent Application Publication
(10) Pub. No.: US 2004/0201750 A1
(43) Pub. Date: Oct. 14, 2004

(54) Apparatus for a multiple function memory card

(76) Inventor: Huang-Tsun Chen, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/986,837

(22) Filed: Nov. 13, 2001

(51) Int. Cl. H04N 5/76

(52) U.S. Cl. 348/231.99

(57) ABSTRACT

This invention relates to an apparatus of memory card, more particularly to an apparatus of a multiple function memory card, which is used in a personal digital assistant (PDA) and comprises functions of a digital camera and a datum memory card. The multiple function memory card of the present invention is fixed in a digital camera and a material of the multiple function memory card is a nonvolatile memory. When the multiple function memory card is connected with the personal digital assistant and a power of the digital camera is opened, a driver, which has been installed in the person digital assistant, will detect the multiple function memory card and will provide two kinds modes to be chosen by a user. When the user choose the digital camera mode, a memory size of the multiple function memory card will provide uses for the digital camera and will be used to save image data. When the user choose the memory card mode, the memory size of the multiple function memory card will provide uses for the personal digital assistant to backup data, which are in the personal digital assistant. The image data and the backup data can be saved in the multiple memory at the same time. Data, which are saved in the multiple function memory card, will not be lost following a power of the personal digital assistant will be closed.

### BACKGROUND OF THE INVENTION

1. Field of the Invention

This invention relates to an apparatus of memory card, more particularly to an apparatus of a multiple function memory card, which is used in a personal digital assistant (PDA) and comprises functions of a digital camera and a common memory card, to increase a using efficiency of the personal digital assistant and decrease peripheral of the personal digital assistant.

2. Description of the Prior Art

The personal digital assistant, which comprises multiple functions like simple word processing, compiling statistics, calculating, database, and drawing forms, is a kind of small computer whose size is similar to a palm. Although a process rate of the personal digital assistant is slower than a notebook, the personal digital assistant provides common functions for users and has abilities in wireless transmission or wires transmission to exchange data from common personal desktop computer to the personal digital assistant. Some of the personal digital assistants also comprise a mobile communication ability and a mobile facsimile ability.

At present, many operation processes of many enterprises are limited by heavy personal desktop computers to have many problems. Therefore, many end point works of a operation process only can use manpower to replace the heavy personal desktop computer. The end point works use the manpower to practice the conclusive proof actions and the key-in actions after the forms are printed from computers. After data are saved in the computer by the key-in actions of the manpower, the operation process is finished. Although desktop computers have strong calculating abilities and can help the enterprise to control more precise data to adjust tactical objective, the operation processes of the enterprise still can not be controlled by using computers consistently.

At present, functions, which are provided by the personal digital assistant, just can be used to deal with the end point works of the operational process. Because the personal digital assistant not only has a characteristic in mobility but also can be connected with the desktop computer. Therefore, the personal digital assistant will accomplish most of works, which were proceeding in the desktop computer. A price of the personal digital assistant is also cheaper than a price of the desktop computer. In order to increase capabilities of the personal digital assistant, there is a lot of peripheral to be used in the personal digital assistant. But a lot of peripheral will decrease the characteristics in mobility and convenience of the personal digital assistant. Therefore, how to integrate the peripherals is the important technology at present.

A volatile memory is most used in the internal memory of the common personal digital assistant. When a power of personal assistant is shut down, data, which were saved in the internal memory, will be lost at the same time. Therefore, the user usually needs a datum memory card to backup internal data of the personal digital assistant. A digital camera is one of the peripherals of the personal digital assistant. The digital camera comprises a buffer to save image data, which are got from the digital camera, for a moment. This buffer is a volatile memory. Therefore, the data, which are saved in the buffer will be lost following a power of the digital camera is shut down. When the user wants to use the digital camera and the datum memory card at any time, the user must bring these two apparatus with himself or herself. This condition will decrease the mobility and convenience of the personal digital assistant.

### SUMMARY OF THE INVENTION

In accordance with the above-mentioned invention backgrounds, the traditional digital camera and datum memory card will decrease the mobility and convenience of the personal digital assistant. The present invention provides an apparatus of a multiple function memory card, which comprises functions of a digital camera and a datum memory card, to integrate peripherals of the personal digital assistant.

The second objective of this invention is to increase the using efficiency of the personal digital assistant by using an apparatus of a multiple function memory card, which comprises functions of a digital camera and a datum memory card.

The third objective of this invention is to decrease the cost of the user by using an apparatus of a multiple function memory card, which comprises functions of a digital camera and a datum memory card.

It is a further objective of this invention to increase capabilities of the personal digital assistant by using an apparatus of a multiple function memory card, which comprises functions of a digital camera and a datum memory card.

In according to the foregoing objectives, the present invention provides an apparatus to integrate the peripherals of the personal digital assistant. The multiple function memory card of the present invention is fixed in a digital camera and a material of the multiple function memory card is a nonvolatile memory. When the multiple function memory card is connected with the personal digital assistant and a power of the digital camera is opened, a driver, which has been installed in the person digital assistant, will detect the multiple function memory card and will provide two kinds modes to be chosen by a user. When the user choose the digital camera mode, a memory size of the multiple function memory card will provide uses for the digital camera and will be used to save image data. When the user choose the memory card mode, the memory size of the multiple function memory card will provide uses for the personal digital assistant to backup data, which are in the personal digital assistant. The image data and the backup data can be saved in the multiple memory at the same time. Data, which are saved in the multiple function memory card, will not be lost following a power of the personal digital assistant will be closed. Therefore, the multiple function memory card of the present invention can increase the using efficiency and capabilities of the personal digital assistant. the multiple function memory card of the present invention can also decrease the cost of the user.

### BRIEF DESCRIPTION OF THE DRAWINGS

In the accompanying drawing forming a material part of this description, there is shown:

FIG. 1 shows a product diagram in connecting with the multiple function memory card of the present invention and the personal digital assistant; and

FIG. 2 shows a connecting diagram of the apparatuses of the present invention.

### DESCRIPTION OF THE PREFERRED EMBODIMENT

The foregoing aspects and many of the attendant advantages of this invention will become more readily appreciated as the same becomes better understood by reference to the following detailed description, when taken in conjunction with the accompanying drawings, wherein:

The traditional digital camera, which is used in the personal digital assistant, comprises a buffer to save image data, which are got from the digital camera, for a moment. But most of this buffer is a volatile memory. When the power of the personal digital assistant is shut down, the data, which were saved in the buffer, will be following lost and can not be saved in the buffer forever. The buffer of the digital camera just provides uses of the digital camera and does not provide uses of others apparatuses. Therefore, the memory size of the buffer is very small and it is just used when the data are transmitted from the digital camera to the personal digital assistant. When the size of the internal memory of the personal digital assistant will be full, the digital camera must be drawn out from an expansion slot of the personal digital assistant and the datum memory card will be fixed to the expansion slot to backup the data of the personal digital assistant. This condition will prevent the size of the internal memory of the personal digital assistant to be full to affect the operational process of the personal digital assistant.

The size of the buffer, which is in the digital camera that is used in the personal digital assistant, is small and a material of the buffer is nonvolatile memory. Therefore, the buffer can not be used to become the datum memory card, which is used to backup the data of the personal digital assistant. When the digital camera stops to proceed, the buffer will not have any action. Therefore, the multiple function memory card, which comprises the functions of the datum memory card and the digital camera, of the present invention must be used to increase the using efficiency of the personal digital assistant.

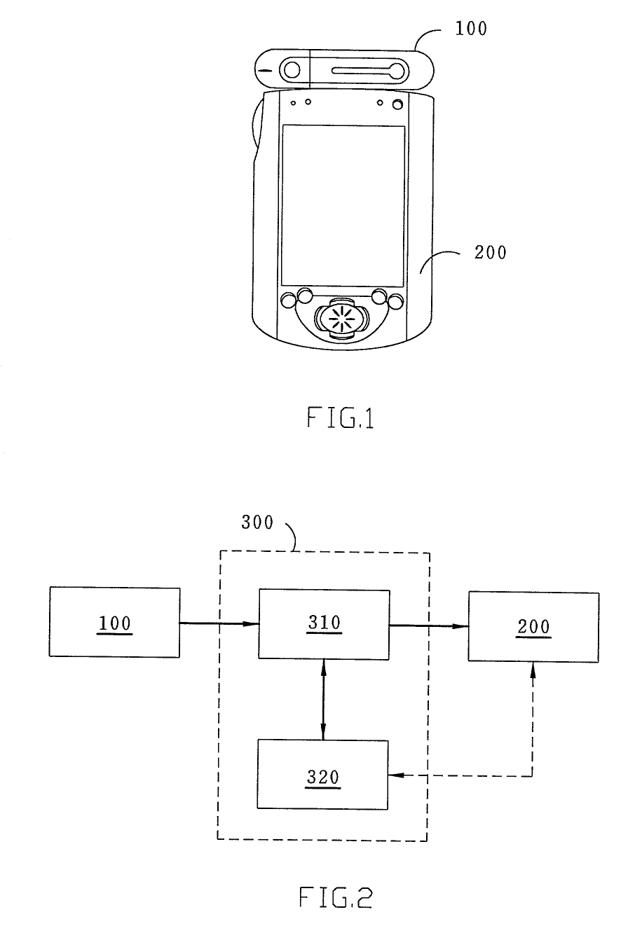

Referring to FIG. 1, this shows a product diagram in connecting with the multiple function memory card of the present invention and the personal digital assistant. The multiple function memory card, which is fixed in the digital camera 100, and the personal digital assistant 200 are connected with each other by using the expansion slot of the personal digital assistant 200. Referring to FIG. 2, this shows a connecting diagram of the apparatuses of the present invention. The multiple function memory card 300 of the present invention comprises a data/signal control unit 310 and a memory 320. The data/signal control unit 310 is connected with the digital camera 100, the personal digital assistant 200, and the memory 320. The memory 320 is connected with the data/signal control unit 310 and the personal digital assistant 200. The multiple function memory card 300 is connected with the digital camera 100 and the personal digital assistant 200. The digital camera 100 is used in the personal digital assistant 200 for a special purpose. In order to increase the capabilities of the personal digital assistant 200, the personal digital assistant 200 comprises an expansion slot to make the peripheral, which is needed for users, connect with the personal digital assistant 200. Therefore, the multiple function memory card 300 is usually connect with the expansion slot of the personal digital assistant 200. This condition will not limit the scope of the present invention. The memory, which is used in the multiple function memory card of the present invention, is usually a nonvolatile memory, such as: compact flash (CF). The compact flash will not limit the scope of the present invention.

At first, the driver of the multiple function memory card 300 of the present invention must be installed into the personal digital assistant 200. After the multiple function memory card 300, which is fixed in the digital camera 100, is connected with the personal digital assistant 200, the driver, which is installed into the personal digital assistant 200, will detect the multiple function memory card 300 and will display two selection icons on the monitor of the personal digital assistant 200. The user can choose what kind of mode that he wants to use the multiple function memory card 300 of the present invention. One selection icon is a digital camera mode and the other is a datum memory card mode.

When the user chooses the digital camera mode and starts the power of the digital camera, the digital camera 100, which is in the multiple function memory card 300, can start to proceed its capabilities. The image data, which are got from the digital camera 100, will be transmitted to the data/signal control unit 310 at first. When an amount of the image data is less, the image data will be transmitted to the personal digital assistant 200 directly after passing through the data/signal control unit 310 and a portrait will be shown on the monitor of the personal digital assistant 200. When the amount of the image data is more, the image data will be saved in the memory 320 at first after passing through the data/signal control unit 310. When the memory is full or the image data are transmitted completely, the data which is saved in the memory, will be transmitted to the personal digital assistant 200 and a portrait will be shown on the monitor of the personal digital assistant 200 to decrease the transmitting between the personal digital assistant 200 and the digital camera 100.

When the user choose the datum memory card mode, the digital camera 100, which is in the multiple function memory card 300, will not start to proceed its capabilities. The memory 320 of the multiple function memory card 300 will provide uses to the personal digital assistant completely. When the user wants to backup the data of the personal digital assistant 200, the user can import the command to the personal digital assistant 200. At this time, the data, which are in the personal digital assistant, will be transmitted from the personal digital assistant 200 to the multiple function memory card to be saved forever.

Because the memory 320 of the multiple function memory card 300 of the present invention is nonvolatile memory. Therefore, the data, which are in the multiple function memory card, will be still preserved when the power of the personal digital assistant is shut down. This condition will avoid the data to be lost to trouble the user.

The best characteristic of the personal digital assistant is that the volume of the personal digital assistant is very small and it has very convenient mobility. But the capability of the personal digital assistant is not very well. In order to conform to the needs of the user, there are a lot of peripherals to increase the capability of the personal digital assistant. When the amount of the amount the peripherals is too much, the convenience of the personal digital assistant will be decreased. Therefore, the multiple function memory card, which combines the functions of the digital camera and the datum memory card, of the present invention will decrease the amount of the peripherals, which is carried by the user and increase the using efficiency of the personal digital assistant.

Because the multiple function memory card of the present invention integrates the functions of the digital camera and the datum memory card. Therefore, the user will not buy both of these two apparatuses when he needs these two functions. This condition will decrease the cost of the user. The user will choose the using mode that he needs by using the personal digital assistant and will not draw out and change the peripherals of the personal digital assistant.

In accordance with the present invention, the present invention provides an apparatus to integrate the peripherals of the personal digital assistant. The multiple function memory card of the present invention is fixed in a digital camera and a material of the multiple function memory card is a nonvolatile memory. When the multiple function memory card is connected with the personal digital assistant and a power of the digital camera is opened, a driver, which has been installed in the person digital assistant, will detect the multiple function memory card and will provide two kinds modes to be chosen by a user. When the user choose the digital camera mode, a memory size of the multiple function memory card will provide uses for the digital camera and will be used to save image data. When the user choose the memory card mode, the memory size of the multiple function memory card will provide uses for the personal digital assistant to backup data, which are in the personal digital assistant. The image data and the backup data can be saved in the multiple memory at the same time. Data, which are saved in the multiple function memory card, will not be lost following a power of the personal digital assistant will be closed. Therefore, the multiple function memory card of the present invention can increase the using efficiency and capabilities of the personal digital assistant. the multiple function memory card of the present invention can also decrease the cost of the user.

Although specific embodiments have been illustrated and described, it will be obvious to those skilled in the art that various modifications may be made without departing from what is intended to be limited solely by the appended claims.

What is claimed is:

1. An apparatus of a multiple function memory card, which is a fixed in a digital camera, said apparatus comprises:
a data/signal control unit, said data/signal control unit being connected with said digital camera and a personal digital assistant to transmit an image datum, which is produced from said digital camera; and
a memory, said memory being connected with said data/signal control unit and said personal digital assistant to save a backuped datum of said personal digital assistant and said image datum.

2. The apparatus according to claim 1, wherein said memory is a volatile memory.

3. The apparatus according to claim 2, wherein said volatile memory is a compact flash.

4. The apparatus according to claim 2, wherein said memory can be used to save said image datum forever.

5. An apparatus of a multiple function memory card, which is a fixed in a digital camera and is used in a personal digital assistant, said apparatus comprises:
a data/signal control unit, said data/signal control unit being connected with said digital camera and a personal digital assistant to transmit an image datum, which is produced from said digital camera;
said personal digital assistant comprising a driver, wherein said personal digital assistant can provide a digital camera mode and a datum memory mode for a user when said driver detects said multiple function memory card; and
a memory, said memory being connected with said data/signal control unit and said personal digital assistant, wherein said memory is used to save said image datum when said digital camera mode is selected and said memory is used to save a backuped datum of said personal digital assistant when said datum memory mode is selected.

6. The apparatus according to claim 5, wherein said memory is a volatile memory.

7. The apparatus according to claim 6, wherein said volatile memory is a compact flash.

8. The apparatus according to claim 5, wherein said memory can be used to save said image datum forever.

9. The apparatus according to claim 5, wherein said memory can be used to save said backuped datum forever.
